(19) United States
(12) Patent Application Publication
(10) Pub. No.: US 2026/0205899 A1
(43) Pub. Date: Jul. 16, 2026

(54) METHODS AND APPARATUSES FOR CELL SWITCHING IN WIRELESS COMMUNICATION SYSTEMS

(71) Applicant: SHARP KABUSHIKI KAISHA, Sakai City, Osaka (JP)

(72) Inventors: CHIA-HUNG LIN, Taipei (TW); MEI-JU SHIH, Taipei (TW); HUNG-CHEN CHEN, Taipei (TW)

(21) Appl. No.: 19/127,909

(22) PCT Filed: Nov. 7, 2023
(86) PCT No.: PCT/CN2023/130155

§ 371 Date: May 7, 2025

Related U.S. Application Data
(60) Provisional application No. 63/423,429, filed on Nov. 7, 2022.

(51) Int. Cl. H04W 36/00

(52) U.S. Cl. CPC H04W 36/0072

(57) ABSTRACT

Methods and apparatuses for a cell switching in wireless communication systems are provided. The method includes receiving one or more candidate cell configurations via Radio Resource Control (RRC) signaling from a source cell; receiving a Medium Access Control (MAC) Control Element (CE) from the source cell, the MAC CE indicating the UE to switch to a target cell that corresponds to a particular candidate cell configurations via RRC cell configuration of the one or more candidate cell configurations, the particular candidate cell configuration including an indication that is set to either a first value or a second value; and determining, based on the indication, whether to apply a same Timing Advance (TA) value to the target cell as is used for the source cell.

### CROSS-REFERENCE TO RELATED APPLICATION(S)

The present disclosure claims the benefit of and priority to U.S. Provisional Patent Application Ser. No. 63/423,429, filed on Nov. 7, 2022, entitled “RACH ENHANCEMENT FOR L1/L2 MOBILITY,” the content of which is hereby incorporated herein fully by reference into the present disclosure for all purposes.

### FIELD

The present disclosure is related to wireless communication and, more specifically, to methods and apparatuses for cell switching in wireless communication systems.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to methods and apparatuses for a cell switching in wireless communication systems.

According to a first aspect of the present disclosure, a method performed by a User Equipment (UE) for a cell switching is provided. The method includes receiving one or more candidate cell configurations via Radio Resource Control (RRC) signaling from a source cell; receiving a Medium Access Control (MAC) Control Element (CE) from the source cell, the MAC CE indicating the UE to switch to a target cell that corresponds to a particular candidate cell configuration of the one or more candidate cell configurations, the particular candidate cell configuration including an indication that is set to either a first value or a second value; and determining, based on the indication, whether to apply a same Timing Advance (TA) value to the target cell as is used for the source cell.

In some implementations of the first aspect of the present disclosure, determining, based on the indication, whether to apply the same TA value to the target cell further includes applying the same TA value to the target cell as is used for the source cell in a case that the indication is set to the first value; and performing a TA value acquisition procedure associated with the target cell in a case that the indication is set to the second value.

In some implementations of the first aspect of the present disclosure, the method further includes in the case that the indication is set to the first value: transmitting uplink data to the target cell after receiving the MAC CE; receiving feedback associated with the uplink data from the target cell; and determining that the cell switching is complete after receiving the feedback from the target cell.

In some implementations of the first aspect of the present disclosure, the method further includes in the case that the indication is set to the first value: monitoring a Physical Downlink Control Channel (PDCCH) based on a Transmission Configuration Indicator (TCI) state indicated by the MAC CE in a case that the particular candidate cell configuration does not configure an uplink grant for the UE to transmit uplink data to the target cell; obtaining an uplink grant from the PDCCH; transmitting, by using the uplink grant, the uplink data to the target cell after receiving the MAC CE; receiving feedback associated with the uplink data from the target cell; and determining that the cell switching is complete after receiving the feedback from the target cell.

In some implementations of the first aspect of the present disclosure, when the indication is set to the first value, the indication signifies an intra-Distributed Unit (intra-DU) relationship between the target cell and the source cell; and when the indication is set to the second value, the indication signifies an inter-Distributed Unit (inter-DU) relationship between the target cell and the source cell.

In some implementations of the first aspect of the present disclosure, the TA value acquisition procedure includes a Random Access Channel (RACH) procedure.

According to a second aspect of the present disclosure, a User Equipment (UE) for a cell switching is provided. The UE includes at least one processor and at least one memory coupled to the at least one processor. The at least one memory stores one or more computer-executable instructions that, when executed by the at least one processor, cause the UE to receive one or more candidate cell configurations via Radio Resource Control (RRC) signaling from a source cell; receive a Medium Access Control (MAC) Control Element (CE) from the source cell, the MAC CE indicating the UE to switch to a target cell that corresponds to a particular candidate cell configuration of the one or more candidate cell configurations, the particular candidate cell configuration including an indication that is set to either a first value or a second value; and determine, based on the indication, whether to apply a same Timing Advance (TA) value to the target cell as is used for the source cell.

In some implementations of the second aspect of the present disclosure, determining, based on the indication, whether to apply the same TA value to the target cell further includes applying the same TA value to the target cell as is used for the source cell in a case that the indication is set to the first value; and performing a TA value acquisition procedure associated with the target cell in a case that the indication is set to the second value.

In some implementations of the second aspect of the present disclosure, the one or more computer-executable instructions, when executed by the at least one processor, further cause the UE to in the case that the indication is set to the first value: transmit uplink data to the target cell after receiving the MAC CE; receive feedback associated with the uplink data from the target cell; and determine that the cell switching is complete after receiving the feedback from the target cell.

In some implementations of the second aspect of the present disclosure, the one or more computer-executable instructions, when executed by the at least one processor, further cause the UE to: in the case that the indication is set to the first value: monitor a Physical Downlink Control Channel (PDCCH) based on a Transmission Configuration Indicator (TCI) state indicated by the MAC CE in a case that the particular candidate cell configuration does not configure an uplink grant for the UE to transmit uplink data to the target cell; obtain an uplink grant from the PDCCH; transmit, by using the uplink grant, the uplink data to the target cell after receiving the MAC CE; receive feedback associated with the uplink data from the target cell; and determine that the cell switching is complete after receiving the feedback from the target cell.

In some implementations of the second aspect of the present disclosure, when the indication is set to the first value, the indication signifies an intra-Distributed Unit (intra-DU) relationship between the target cell and the source cell; and when the indication is set to the second value, the indication signifies an inter-Distributed Unit (inter-DU) relationship between the target cell and the source cell.

In some implementations of the second aspect of the present disclosure, the TA value acquisition procedure includes a Random Access Channel (RACH) procedure.

According to a third aspect of the present disclosure, a Base Station (BS) for managing a cell switching of a User Equipment (UE) is provided. The BS includes at least one processor and at least one memory coupled to the at least one processor. The at least one memory stores one or more computer-executable instructions that, when executed by the at least one processor, cause the BS to transmit one or more candidate cell configurations to the UE via Radio Resource Control (RRC) signaling; and transmit a Medium Access Control (MAC) Control Element (CE) to the UE, the MAC CE indicating the UE to switch to a target cell that corresponds to a particular candidate cell configuration of the one or more candidate cell configurations, the particular candidate cell configuration including an indication that is set to either a first value or a second value. The MAC CE enables the UE to determine, based on the indication, whether to apply a same Timing Advance (TA) value to the target cell as is used for a source cell.

In some implementations of the third aspect of the present disclosure, the one or more computer-executable instructions, when executed by the at least one processor, further cause the BS to enable the UE to apply the same TA value to the target cell as is used for the source cell by setting the indication to the first value; and enable the UE to perform a TA value acquisition procedure associated with the target cell by setting the indication to the second value.

In some implementations of the third aspect of the present disclosure, when the indication is set to the first value, the indication signifies an intra-Distributed Unit (intra-DU) relationship between the target cell and the source cell; and when the indication is set to the second value, the indication signifies an inter-Distributed Unit (inter-DU) relationship between the target cell and the source cell.

In some implementations of the third aspect of the present disclosure, the TA value acquisition procedure includes a Random Access Channel (RACH) procedure.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating a handover procedure, according to an example implementation of the present disclosure.

FIG. 2 is a diagram illustrating a method for Layer 1 (L1)/Layer 2 (L2) mobility operations, according to an example implementation of the present disclosure.

FIG. 3 is a flowchart of a method for a cell switching, according to an example implementation of the present disclosure.

FIG. 4 is a diagram illustrating a procedure for determining the TA value by the UE, according to an example implementation of the present disclosure.

FIG. 5 is a block diagram illustrating a node for wireless communication, according to an example implementation of the present disclosure.

### DESCRIPTION

Some of the abbreviations used in this disclosure include: Abbreviation Full name

| Abbreviation | Full name |
|---|---|
| 3GPP | 3^{rd} Generation Partnership Project |
| 5G | 5^{th} Generation |
| 5GC | 5G Core |
| ARFCN | Absolute Radio-Frequency Channel Number |
| AS | Access Stratum |
| ASN.1 | Abstract Syntax Notation One |
| BS | Base Station |
| BWP | Bandwidth Part |
| CA | Carrier Aggregation |
| CAG | Closed Access Group |
| CG | Configured Grant |
| CJT | Coherent Joint Transmission |
| CN | Core Network |
| CSI | Channel State Information |
| CSI-RS | Channel State Information-Reference Signal |
| CU | Central Unit |
| DAPS | Dual Active Protocol Stack |
| DC | Dual Connectivity |
| DCI | Downlink Control Information |
| DL | Downlink |
| DMRS | Demodulation Reference Signal |
| DRB | Data Radio Bearer |
| DU | Distributed Unit |
| E-UTRA(N) | Evolved Universal Terrestrial Radio Access (Network) |
| EN-DC | E-UTRA NR Dual Connectivity |
| EPC | Evolved Packet Core |
| eMTC | enhanced Machine Type Communication |
| FDD | Frequency Division Duplexing |
| FR1 | Frequency Range 1 |
| FR2 | Frequency Range 2 |
| GEO | Geostationary Equatorial Orbit |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| L1 | Layer 1 |
| L2 | Layer 2 |
| L3 | Layer 3 |
| LAN | Local Area Network |
| LCID | Logical Channel ID |
| LEO | Low Earth Orbit |
| LTE | Long Term Evolution |
| LTM | Lower Layer Triggered Mobility |
| MAC | Medium Access Control |
| MAC CE | MAC Control Element |
| MCG | Master Cell Group |
| MIB | Master Information Block |
| MN | Master Node |
| MSG | Message |
| MSG1 | Message 1 |
| MSG2 | Message 2 |
| MSG3 | Message 3 |
| MSG4 | Message 4 |
| MSGA | Message A |
| MSGB | Message B |
| MT | Mobile Termination |
| MTC | Machine Type Communication |
| NAS | Non-Access Stratum |
| NB-IoT | Narrow Band Internet of Things |
| NE-DC | NR - E-UTRA Dual Connectivity |
| NPN | Non-Public Network |
| NR | New Radio |
| NR-U | NR Unlicensed |
| NTN | Non-Terrestrial Network |
| NW | Network |
| OFDM | Orthogonal Frequency-Division Multiplexing |
| PBCH | Physical Broadcast Channel |
| PCell | Primary Cell |
| PCI | Physical Cell Identity |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical (layer) |
| PLMN | Public Land Mobile Network |
| PNI-NPN | Public Network Integrated Non-Public Network |
| PRACH | Physical Random Access Channel |
| PSCell | Primary SCG Cell/Primary Secondary Cell |
| PUCCH | Physical Uplink Control Channel |
| PUSCH | Physical Uplink Shared Channel |
| RA | Random Access |
| RACH | Random Access Channel |
| RAN | Radio Access Network |
| RAR | Random Access Response |
| RAT | Radio Access Technology |
| RF | Radio Frequency |
| RLC | Radio Link Control |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSSI | Received Signal Strength Indication |
| RSRQ | Reference Signal Receiving Quality |
| SCell | Secondary Cell |
| SCG | Secondary Cell Group |
| SDT | Small Data Transmission |
| SFN | Single-Frequency Network |
| SI | System Information |
| SIB | System Information Block |
| SL | Sidelink |
| SMTC | SSB-based Measurement Timing Configuration |
| SN | Secondary Node |
| SNPN | Stand-alone Non-Public Network |
| SR | Scheduling Request |
| SRB | Signaling Radio Bearer |
| SRS | Sounding Reference Signal |
| SSB | Synchronization Signal and PBCH Block |
| SUL | Supplementary Uplink |
| TA | Timing Advance |
| TAG | Timing Advance Group |
| TAT | Time Alignment Timer |
| TCI | Transmission Configuration Indication |
| TDD | Time Division Duplexing |
| TN | Terrestrial Network |
| TRP | Transmission Reception Point |
| TRS | Tracking Reference Signal |
| TS | Technical Specification |
| TX | Transmission |
| UE | User Equipment |
| UL | Uplink |
| UL-CG | Uplink-Configured Grant |
| USIM | Universal Subscriber Identity Module |
| V2X | Vehicle-to-Everything |
| VSAT | Very Small Aperture Terminal |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

Examples of some selected terms in the present disclosure are provided as follows.

Antenna Panel: It may be assumed that an antenna panel is an operational unit for controlling a transmit spatial filter/beam. An antenna panel is typically consisted of a plurality of antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

Beam: The term “beam” here may be replaced with spatial filter. For example, when a UE reports a preferred gNB TX beam, the UE is essentially selecting a spatial filter used by the gNB. The term “beam information” may be used to provide information about which beam/spatial filter has been used/selected. An apparatus (e.g., a UE or a BS) may transmit individual reference signals by applying individual beams (spatial filters). Thus, a beam (or beam information) may be represented by reference signal resource index(es).

DCI: DCI stands for Downlink Control Information. Various DCI formats are used in LTE within the PDCCH. A DCI format may be a predefined format that packages or forms the downlink control information for transmission in the PDCCH.

TCI State: A TCI state may contain parameters for configuring a QCL relationship between one or two reference signals and a target reference signal set. For example, a target reference signal set may be the DM-RS ports of the PDSCH, PDCCH, PUCCH or PUSCH.

HARQ: HARQ functionality ensures reliable delivery between peer entities at Layer 1 (L1) (e.g., the Physical Layer). When the physical layer is not configured for downlink/uplink spatial multiplexing, a single HARQ process supports one Transport Block (TB). When the physical layer is configured for downlink/uplink spatial multiplexing, a single HARQ process may support one or multiple TBs. There is one HARQ entity for each serving cell. Each HARQ entity supports a parallel number of downlink (DL) and uplink (UL) HARQ processes.

Additionally, in the present disclosure, the terms “source cell,” “source serving cell,” “source serving beam,” “source beam,” and “source gNB” can be used interchangeably. The terms “target cell,” “target serving cell,” “target serving beam,” “target beam,” and “target gNB” can be used interchangeably.

In NR, handover is one of the key features designed to provide better user experiences and ensure service continuity. The NR handover feature is developed based on LTE handover mechanisms. Specifically, a UE may provide a measurement report to a gNB after/at the time certain measurement report events are triggered. Following this, the gNB may indicate to the UE whether to initiate a handover procedure based on the measurement report. During the handover procedure, the UE may transition from the source gNB to the target gNB.

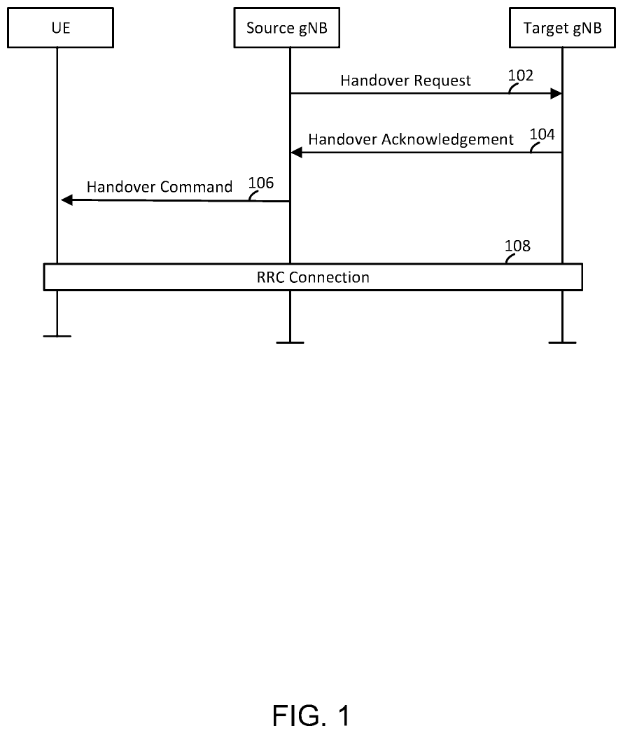

FIG. 1 is a diagram illustrating a handover procedure, according to an example implementation of the present disclosure.

As illustrated in FIG. 1, in action 102, the source gNB may transmit a Handover Request to a target gNB to initiate the handover procedure.

In action 104, the target gNB may transmit a Handover Acknowledgement, as a response to the Handover Request, to the source gNB.

In action 106, the source gNB may transmit a Handover Command to the UE. The Handover Command may include the configurations corresponding to the target gNB. For example, the Handover Command may include (or be included in) an RRC reconfiguration message that includes the configuration of the target gNB received in the Handover Acknowledgement.

In action 108, the UE may access the target cell according to the information/configuration included in the Handover Command, and establish an RRC connection to the target gNB and transmit a Handover Complete message (e.g., an RRC reconfiguration complete message) to the target gNB. Thereafter, the UE may begin receiving DL data from, and transmitting UL data to, the target gNB.

To improve user experience, minimize interruption time, and enhance service continuity, an L1/L2 mobility procedure (or ‘LTM procedure’) may be implemented to reduce HO latency in NR. In this context, L1 refers to the Physical layer, while L2 can refer to the MAC, RLC, and/or PDCP layers. The L1/L2 mobility procedure may efficiently reduce the latency associated with the traditional HO, as decisions and measurements occur at the L2 and/or L1 layers of devices (e.g., the UE or gNB). Specifically, the L1/L2 mobility procedure may refer to a specific type of cell switching. When the UE is performing the L1/L2 mobility procedure, the primary layers involved in processing the related signaling are L1 and/or L2. By focusing the operations at L1 and/or L2, the device benefits from reduced latency, making the HO or cell switching process more efficient and quicker. It should be noted that in the present disclosure, the terms ‘L1/L2 mobility’, ‘LTM’, and ‘L1/L2 cell switch’ may be utilized interchangeably.

In some implementations, in the L1/L2 mobility procedure, the source cell/gNB may initially configure the UE with candidate cells and beam measurement information (e.g., via an RRC reconfiguration message). Subsequently, the UE may perform beam measurement and report the measurement results back to the source cell/gNB. Based on the measurement results, the source cell/gNB may determine whether the UE needs to change the serving cell/beam. If a change of the serving cell/beam is needed, the source cell/gNB may indicate to the UE to change the serving cell/beam. Following the indication from the source cell/gNB, the UE may change the serving cell/beam to a target serving cell/beam. Thereafter. the UE may perform data reception and/or transmission using the target serving cell/beam. For example, the UE may receive DL data via/from the target serving cell/beam and may transmit UL data via/to the target serving cell/beam.

To further reduce the latency caused by performing the L1/L2 mobility procedure, the present disclosure proposes several schemes for acquiring the TA information (e.g., the TA value(s)) of the target serving cells in the L1/L2 mobility procedure.

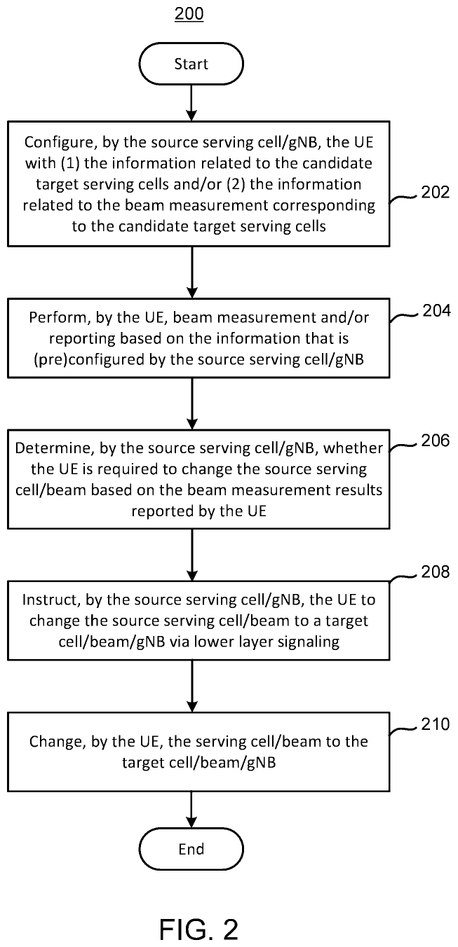

FIG. 2 is a diagram illustrating a method 200 for an L1/L2 mobility procedure, according to an example implementation of the present disclosure.

In action 202, the source serving cell/gNB may configure the UE with (1) the information (or the candidate target serving cells information) associated with the candidate target serving cell(s) and/or (2) the information (or the beam measurement information) associated with the beam measurement corresponding to the candidate target serving cell(s).

In some implementations, the candidate target serving cells information may include the cell ID(s) associated with the candidate target serving cell(s). In some implementations, the beam measurement information may include a beam measurement configuration that includes at least one of the following: a beam report configuration, the associated beam information (e.g., a beam ID, an SSB index, and/or a CSI-RS index), and/or the associated cell ID. In some implementations, the beam measurement information may include one or more IDs/Indices (e.g., the beam ID(s), the SSB index(s), and/or the CSI-RS index(s)). In some implementations, the beam measurement information may be included in the associated beam report configuration.

In action 204, the UE may perform beam measurement and/or reporting based on the information that is (pre)configured by the source serving cell/gNB in action 202.

In action 206, the source serving cell/gNB may determine, based on the beam measurement results reported by the UE, whether the UE is required to change the source serving cell/beam.

In action 208, the source serving cell/gNB may indicate to the UE to change the source serving cell/beam to a target cell/beam/gNB via lower layer signaling (e.g., MAC CE and/or DCI signaling).

In action 210, the UE may change the serving cell/beam to the target cell/beam/gNB.

The TA information of the target serving cell may be acquired either before action 206 or after action 206, based on various TA information acquisition mechanisms described in the present disclosure. Additional details for several actions involved in the L1/L2 mobility procedure are also provided in the following sections of the present disclosure. Please note that the implementations described in different sections of the present disclosure can be combined with each other. These implementations may pertain to the L1/L2 mobility procedure and may describe different or similar aspects of the operations.

In some implementations, the UE may be provided with one or more pre-configurations from a serving cell through dedicated RRC signaling. Each pre-configuration may include at least one of the following pieces of information, from (1) to (21), associated with different candidate target cells and/or the serving cell:
(1) The PCI of the candidate target cell.
(2) The list of PCIs for the candidate target cells.
(3) The serving cell index.
(4) The reporting criteria: For example, the thresholds related to the RSRP, RSRQ, and/or RSSI for the current serving cell, and/or the thresholds related to RSRP, RSRQ, and/or RSSI for the candidate target cell.
(5) One or more TCI states corresponding to a candidate target cell.
(6) One or more TCI states corresponding to multiple candidate target cells.
(7) The index corresponding to the order of TCI states in a TCI state list.
(8) The TAG ID.
(9) The TAT.
(10) The index (e.g., the IE additionalPCI or AdditionalPCIIndex) corresponding to the order/ranking/position of a candidate target cell in a list (e.g., the IE additionalPCIList)
(11) The RACH occasion corresponding to different candidate target cells.
(12) The SSB burst set and associated parameters (e.g., the IE SSB-to-Measure) for different candidate target cells.
(13) The transmit power of the SSB for different candidate target cells.
(14) The periodicity of the SSB for different candidate target cells.
(15) The subcarrier spacing(s) of the SSBs (relative to the IE subcarrierSpacingSSB) for different candidate target cells.
(16) The SMTCs for different candidate target cells.
(17) The configuration associated with the CSI-RS for channel measurement.
(18) The list of CSI-RSs for channel measurement.
(19) The configuration corresponding to the TRS for channel measurement.
(20) The list of TRSs for channel measurement.
(21) An identifier to indicate whether the relationship between the serving cell and the candidate target cell is inter-DU or intra-DU (e.g., ‘0’ means inter-DU and ‘1’ means intra-DU, or vice versa, where ‘1’ means inter-DU and ‘0’ means intra-DU).

In the present disclosure, the term ‘inter-DU’, ‘inter-DU relationship’, or ‘inter-DU case’ may refer to operations, communications, or relationships that occur between two or more distinct DUs. In the context of wireless communication, this may mean that actions or exchanges are taking place between different DUs. On the other hand, the term ‘intra-DU’, ‘intra-DU relationship’, or ‘intra-DU case’ may pertain to operations, communications, or relationships that occur within a single DU.

In some implementations, the UE may be provided with multiple pre-configurations corresponding to different candidate target cells by the network via at least one RRC message. For example, if there are X pre-configurations, then there are also X candidate target cells, and each of the X pre-configurations may correspond to one of the X candidate target cells, and there may be a one-to-one mapping between the candidate target cells and the pre-configurations. These pre-configurations may be included in an IE, such as CellGroupConfig, ServingCellConfig, or RRCReconfiguration. Moreover, each pre-configuration may include at least one of the following pieces of information, from (1) to (9), corresponding to the associated candidate target cell(s):
(1) A PCI.
(2) The IE additionalPCI (or the logical index used to identify the LTM candidate cell).
(3) The TAG ID.
(4) The TCI state(s) (e.g., the DL TCI state(s), the UL TCI state(s), and/or the joint TCI state(s)).
(5) The RACH configuration (e.g., the list of RACH occasions, and/or the preamble indexes).
(6) The SSB configuration(s) (e.g., the SMTC, the SSB transmit power, the periodicity of the SSB, the subcarrier spacing of the SSB, and/or the SSB positions in a burst).
(7) The CSI-RS configuration (e.g., the subcarrier spacing of the CSI-RS(s), the measurement bandwidth of CSI-RS(s), the list of CSI-RS(s) for measurement, the SSB index associated with the CSI-RS(s) for measurement, the IE additionalPCIindex associated with the CSI-RS for measurement, the CSI-RS index, the scrambling ID for the CSI-RS, the first OFDM symbol of the CSI-RS in time domain, and/or the frequency density for the CSI-RS(s)).
(8) The TRS configuration (e.g., the frequency domain density of the TRS(s), the time domain density of the TRS(s), the IE resourceElementOffset).
(9) An identifier to identify whether the relationship between the serving cell and a candidate target cell is inter-DU or intra-DU (e.g., ‘0’ means inter-DU and ‘1’ means intra-DU, or vice versa, where ‘1’ means inter-DU and ‘0’ means intra-DU).

In some implementations, each LTM candidate cell may be associated with an LTM candidate cell configuration. The UE may be provided with a specific list (e.g., an additionalPCIlist or an SSB configuration list) in addition to the LTM candidate cell configurations and/or the pre-configurations corresponding to different candidate target cells. In some implementations, the list may not be included in the LTM candidate cell configuration. Each SSB configuration in the list may be associated with a logical index to identify the LTM candidate cell. The list and the pre-configurations may be configured by the serving cell, the serving base station, or the serving gNB. The list may include multiple SSB configurations associated with different candidate target cells. An SSB configuration may include at least one of the following: the SMTC, the SSB transmit power, the periodicity of the SSB, the subcarrier spacing of the SSB, the SSB positions in the burst, and/or the number of SSBs. Each SSB configuration may be associated with an additional PCI index (e.g., the IE additionalPCIIndex), where each additionalPCIIndex may be associated with a candidate target cell. Following the structure of the list, every pre-configuration corresponding to a different candidate target cell may include an additionalPCIIndex.

In some implementations, the pre-configurations (corresponding to different candidate target cells) and one or more lists of the TCI states may be configured for a UE. The TCI state list(s) and the pre-configurations may be configured by the serving cell, the serving base station, or the serving gNB. The lists of the TCI states (e.g., the UL TCI states, the DL TCI states, the joint TCI states, and/or TCI states configured for L1/L2 mobility) may include different TCI states associated with different candidate target cells or serving cells. For example, each TCI state within the list of the TCI states may include an index (e.g., the additionalPCI, the AdditionalPCIIndex, or a logical index used to identify the LTM candidate cell) that associates with one or more candidate target cells.

In some implementations, a UE may be configured, by the gNB, with multiple pre-configurations corresponding to different candidate target cells. Each pre-configuration may include a specific IE that indicates whether the relationship between the associated candidate target cell and the serving cell is inter-DU or intra-DU. In some implementations, the IE may be included in the LTM candidate cell configuration. In some implementations, the IE may adopt an ENUMERATED format (e.g., ENUMERATED{‘inter-DU’, ‘intra-DU’}). In some implementations, if the bit specified by the IE is set to ‘0’, the relationship between the associated candidate target cell and the serving cell is ‘inter-DU’ if the IE is formatted as ENUMERATED{‘inter-DU’, ‘intra-DU’} or ENUMERATED{‘inter-DU’}. If the IE format is ENUMERATED{‘intra-DU’} and the bit is absent, the relationship remains ‘inter-DU’. Conversely, if the bit specified by the IE is set to ‘1’, the relationship between the associated candidate target cell and the serving cell is ‘intra-DU’ if the IE is formatted as ENUMERATED{‘inter-DU’, ‘intra-DU’} or ENUMERATED{‘intra-DU’}. If the IE format is ENUMERATED{‘inter-DU’} and the bit is absent, the relationship between the associated candidate target cell and the serving cell is ‘intra-DU’. In some implementations, if the bit specified by the IE is ‘1’, the relationship between the associated candidate target cell and the serving cell is defined as ‘inter-DU’. If the bit specified by the IE is ‘0’, the relationship between the associated candidate target cell and the serving cell is defined as ‘intra-DU’. In some implementations, if the pre-configuration does not specify the inter-DU/intra-DU relationship (e.g., the field is absent), the UE may assume the candidate target cell is an inter-DU.

In some implementations, a UE may be configured by the gNB/BS with one or more RACH configurations, where the one or more RACH configurations may be dedicated for the L1/L2 mobility procedure. In some implementations, the RACH configuration(s) may be a common RACH configuration applicable for all LTM candidate cells. In some implementations, the gNB/BS may configure the UE with several preamble indexes (e.g., the preamble indexes ranging from preamble #31 to preamble #41). The preamble indexes may be dedicated for a RACH procedure corresponding to the L1/L2 mobility procedure. In some such implementations, the gNB/BS may further configure the UE with one or more common RACH occasions. The one or more RACH configurations may be used for preamble transmission corresponding to the RACH procedure for the L1/L2 mobility procedure.

In some implementations, a UE may be configured with a bitmap/indication that indicates whether the relationship between each candidate target cell and the serving cell is either ‘inter-DU’ or ‘intra-DU’. For example, the UE may receive the bitmap/indication via an IE, a MAC CE, or DCI from the serving cell, and the bitmap/indication may be included in the IE, the MAC CE, or the DCI. As an example, if the UE is configured with seven candidate target cells and the bitmap is set as ‘1001011’, this may suggest that the relationship between the candidate target cells #0, #3, #5, and #6 with the serving cell is ‘inter-DU’, while the relationship between the candidate target cells #1, #2, and #4 with the serving cell is ‘intra-DU’. In another scenario, the sequence of interpreting the bits may be reversed. For example, using the same bitmap configuration ‘1001011’, the candidate target cells #0, #1, #3, and #6 may have an ‘inter-DU’ relationship with the serving cell, while the candidate target cells #2, #4, and #5 may have an ‘intra-DU’ relationship. It should be noted that the index of the candidate target cell may be, but not limited to, the additionalPCIIndex or the serving cell index. The size of the bitmap may be the maximum number of the candidate target cells that can be configured for the UE or the number of candidate target cells already configured for the UE. In some implementations, the bitmap/indication that indicates whether the relationship between each candidate target cell and the serving cell is either ‘inter-DU’ or ‘intra-DU’ may not be included in the LTM candidate cell configuration(s).

In some implementations, a UE may acquire the initial TA value(s) for each candidate target cell before receiving the cell switch command from the gNB/BS. The cell switch command may be provided by (or included in) DCI or a MAC CE (e.g., a cell switch MAC CE).

In some implementations, the NW may instruct a UE on whether to perform a TA value acquisition procedure to acquire the TA value of a candidate target cell before transmitting to the UE a corresponding cell switch command associated with the candidate target cell. In some implementations, the NW may provide the instructions based on whether the current serving cell and the candidate target cell are associated with different DUs (e.g., for the inter-DU case) or the same DU (e.g., for the intra-DU case). For example, the NW may indicate to the UE whether to perform a TA value acquisition procedure to acquire the TA value of a candidate target cell before transmitting to the UE a corresponding cell switch command associated with the candidate target cell in case that the current serving cell and the candidate target cell belong to different DUs (e.g., for the inter-DU case). For example, the NW may indicate to the UE whether to perform a TA value acquisition procedure to acquire the TA value of a candidate target cell before transmitting to the UE a corresponding cell switch command associated with the candidate target cell in case that the current serving cell and the candidate target cell belong to the same DU (e.g., for the intra-DU case).

In some implementations, a UE may perform a TA value acquisition procedure to obtain the TA value of a candidate target cell when the current serving cell and the candidate target cell belong to different DUs (e.g., for the inter-DU case). In some implementations, the NW may instruct a UE on whether to perform a TA value acquisition procedure for the TA value of a candidate target cell before transmitting to the UE a corresponding cell switch command associated with the candidate target cell in a case that both the current serving cell and the candidate target cell belong to the same DU (e.g., for the intra-DU case).

In some implementations, a NW may instruct a UE to perform a TA value acquisition procedure to acquire the TA value of a candidate target cell. In some implementations, a NW may instruct a UE to perform a TA value acquisition procedure to acquire the TA value of a candidate target cell via a MAC CE or DCI. In some implementations, the MAC CE may include a field indicating the candidate target cell ID. In some implementations, if the number of candidate target cells for the LTM procedure is fewer than 8, the MAC CE may employ a single-octet bitmap to denote which candidate target cell(s) should proceed with the TA value acquisition procedure; otherwise, four octets may be used. In some implementations, the DCI may include a field to indicate the candidate target cell ID.

In some implementations, a UE may acquire an initial TA value of a candidate target cell for the LTM procedure during a measurement gap. In some implementations, the UE may be configured with a measurement gap configuration specific for the LTM procedure. In some implementations, the UE may acquire an initial TA value of a candidate target cell for the LTM procedure during a valid measurement gap.

In some implementations, after reporting a beam measurement result for a candidate target cell (e.g., when the reporting criteria are met), a UE may automatically perform a TA value acquisition procedure for the candidate target cell. In some implementations, the UE may perform the TA acquisition based on the NW's pre-configuration once the UE reports the beam measurement result for the candidate target cell. In some implementations, the TA value acquisition procedure may be done through either a contention-based RACH procedure or a contention-free RACH procedure.

In some implementations, upon receiving a pre-configuration for the LTM procedure associated with a candidate target cell, a UE may periodically perform a TA value acquisition procedure to acquire the TA value for the candidate target cell. In some implementations, upon receiving a pre-configuration for the LTM procedure associated with a candidate target cell, the UE may perform the TA value acquisition procedure based on a timer, which starts upon the UE acquiring an initial TA value. When the timer expires, the UE may initiate the TA value acquisition procedure again. If a new TA value is acquired (e.g., from a RACH procedure or upon NW's instruction), the timer may be started or restarted. The NW may provide the UE with a new TA value for the candidate target cell via a MAC CE or DCI.

In some implementations, the UE may perform the RACH procedure for each candidate target cell via the L1/L2 mobility-dedicated (or ‘LTM-dedicated’) RACH configuration(s) provided by the gNB/BS.

In some implementations, the UE may be configured with a common RACH occasion dedicated for L1/L2 mobility (e.g., via the common LTM-dedicated RACH configuration(s) for all LTM candidate cells). Subsequently, the UE may use different transmit beams corresponding to the SSBs/TCI states designated for various candidate target cells when performing the RACH procedure on the common RACH occasion. The UE may not perform the RACH procedures for different candidate target cells simultaneously.

In some implementations, each candidate target cell may be associated with a RACH occasion for performing its corresponding RACH procedure. The UE may then use transmit beams corresponding to the SSBs/TCI states configured for each candidate target cell when performing the RACH procedure on the respective RACH occasions. The UE may not perform the RACH procedures for different candidate target cells simultaneously. In some implementations, each LTM candidate cell may be configured with one or more LTM-dedicated RACH configurations.

In some implementations, a preamble group (e.g., from preamble #48 to preamble #63) may be configured for the UE to carry out the RACH procedures for different candidate target cells. The UE may then use the preambles within the preamble group to perform the RACH procedures for the candidate target cells.

In some implementations, the UE may be configured with one or more threshold values (e.g., the RSRP threshold value(s), the RSSI threshold value(s), and/or the threshold RSRQ value(s)) to determine whether to initiate an (L1/L2) cell switching. The UE may then perform the RACH procedures for those candidate target cells with the measured RSRP/RSSI/RSRQ values that exceed the configured threshold value(s) (e.g., the signal quality/strength of the measured RSRP/RSSI/RSRQ values is better than the configured metric(s)) before receiving a cell switch command.

In some implementations, a UE may acquire the initial TA value for a candidate target cell after receiving the cell switch command from the gNB/BS. The cell switch command may be transmitted via DCI or a MAC CE. Additionally, the measured RSRP, RSSI, and/or RSRQ value(s) may represent the quality of a configured beam (e.g., a CSI-RS or an SSB) associated with a candidate target cell or the quality of a candidate target cell.

In some implementations, the UE may be configured with one or more threshold values (e.g., the RSRP threshold value(s), the RSSI threshold value(s), and/or the threshold RSRQ value(s)) to determine whether to initiate an L1/L2 cell switching. The UE may then determine whether to perform an LTM procedure for each candidate target cell based on the measured RSRP/RSSI/RSRQ value(s) corresponding to each candidate cell. For example, if the measured RSRP/RSSI/RSRQ value of a candidate target cell exceeds the configured threshold value, the UE may perform the LTM procedure for that specific candidate target cell.

In some implementations, the cell switch command may indicate to the UE which candidate target cell to switch to. The UE may then utilize the transmit beams corresponding to the configured SSB(s)/TCI state(s) for the indicated candidate target cells to perform the RACH procedure. The SSB(s)/TCI state(s) configured for the candidate target cells may be specified in the cell switch command or within the pre-configuration associated with the candidate target cell to which the UE switches. In some implementations, the cell switch command (e.g., a cell switch MAC CE) may provide the UE with at least one of the following pieces of information: (1) the LTM candidate cell index, (2) the TCI state used for the target cell (e.g., LTM candidate cell indicated by the LTM candidate cell index), (3) the SSB configuration used for the target cell, and (4) the instructions on whether to perform RACH for the target cell. If the cell switch command instructs the UE to perform the RACH procedure for the target cell, the UE may perform the RACH procedure based on the TCI state and/or SSB configuration specified in the cell switch command. In some implementations, the instructions on whether to perform RACH for the target cell may include one or more fields corresponding to the contention-free RACH. If the cell switch command provides the contention-free RACH-related information, the UE may perform RACH (e.g., a cell-switch-command-initiated RACH) after receiving the cell switch command. The PRACH transmission initiated by the cell switch command may be transmitted to the target cell based on the TCI state or SSB indicated in the cell switch command.

In some implementations, if the TCI state configured for a candidate target cell, as indicated by the serving cell/gNB/BS for a cell switching, is associated with the SSB of the serving cell, the UE may not initiate the RACH procedure to acquire the initial TA value for the candidate target cell. In other words, the initial TA value of the candidate target cell may be aligned with (or set as) the initial TA value (or the current TA value) of the serving cell. Moreover, the UE may maintain the TA value(s) based on the MAC CE that contains the TAG ID configured for the serving cell.

In some implementations, if the relationship between the candidate target cell and the serving cell is intra-DU, the UE may apply the initial TA value (or the current TA value) of the serving cell to the candidate target cell. Furthermore, the UE may expect that the TAG ID configured for the candidate target cell is the same as the TAG ID configured for the serving cell.

In some implementations, when the pre-configuration of a candidate target cell includes information indicating an intra-DU relationship between the candidate target cell and the serving cell, the TAG ID field in the pre-configuration may be omitted. Additionally, the UE may maintain the TA value of the candidate target cell based on the TAG ID of the serving cell. In some implementations, each LTM candidate cell configuration may include an RRC field indicating whether the TA value of the candidate cell is the same as the TA of the serving cell. If the RRC field indicates that the TA of the candidate cell is the same as the TA of the serving cell, the UE may apply the TA value of the serving cell to the candidate cell.

In some implementations, one or more SRS resource sets (e.g., the parameter SRS-ResourceSet or SRS-PosResourceSet) may be configured for a UE to perform an L1/L2 cell switching without initiating a RACH procedure.

In some implementations, in a case that some or all candidate target cells are synchronized with the serving cell, the UE may be configured with an SRS resource set with a usage set to ‘L1/L2 mobility’, ‘LTM’, or ‘mobility’. This SRS resource set, with its usage set to ‘L1/L2 mobility’, ‘LTM’, or ‘mobility’, may include one or more SRS resources. Each SRS resource may be associated with a candidate target cell that is synchronized with the serving cell. Specifically, the TCI state(s) configured for each SRS resource may correspond to the SSBs/TCI states configured for each synchronized candidate target cell. For example, each SRS resource within the SRS resource set with a usage set to ‘L1/L2 mobility’, ‘LTM’, or ‘mobility’ may be associated with one additionalPCIIndex.

In some implementations, when multiple SRS resources are included in the SRS resource set with the usage defined as ‘L1/L2 mobility’, ‘LTM’, or ‘mobility’, the UE may expect that the number of SRS ports in the SRS is one (e.g., a single port). Moreover, each SRS resource may be associated with the SSB(s)/TCI state(s) corresponding to different candidate target cell(s). For example, if there are eight candidate target cells configured for a UE, then the UE may be configured with an SRS resource set with a usage set to ‘L1/L2 mobility’, ‘LTM’, or ‘mobility’. This SRS resource set may include eight SRS resources, each associated with the SSB(s)/TCI state(s) associated with one of the eight candidate target cells. In some implementations, the relationship between the SRS resources and the candidate target cells may be a one-to-one mapping.

In some implementations, the UE may be configured with an SRS resource set by the gNB/BS, with a usage set to ‘L1/L2 mobility’, ‘LTM’, or ‘mobility’. Subsequently, the UE may transmit the SRS resources associated with different candidate target cells. When/after each candidate target cell receives the SRS resource transmitted by the UE, each candidate target cell may inform the serving cell about the time it received the SRS resource. The serving cell may then acquire the information corresponding to the TA value(s) of each candidate target cell.

In some implementations, the UE may maintain the TA value(s) for each candidate target cell based on the initial TA value (or the current TA value) of the serving cell and the TA command MAC CEs provided by the serving cell. Each TA command MAC CE may be associated with a candidate target cell via an additionalPCIIndex.

In some implementations, in a case that some or all candidate target cells synchronize with the serving cell, the UE may be configured with multiple SRS resource sets, each with a usage set to ‘L1/L2 mobility’, ‘LTM’, or ‘mobility’. Each SRS resource may include one or more SRS resources. Each SRS resource within an SRS resource set may be associated with a candidate target cell that synchronizes with the serving cell. For example, the TCI state(s) configured for each SRS resource within an SRS resource set may correspond to the SSBs or TCI states configured for a synchronized candidate target cell. Furthermore, each SRS resource set with the usage set to ‘L1/L2 mobility’, ‘LTM’ or ‘mobility’ may be associated with an additionalPCIIndex.

In some implementations, the UE may be configured with multiple SRS resource sets with the usage set to ‘L1/L2 mobility’, “LTM’, or ‘mobility’ by the gNB/BS. The UE may transmit the SRS resources in the SRS resource sets associated with different candidate target cells. When a candidate target cell receives the SRS resource transmitted by the UE, the candidate target cell may inform the serving cell of the time it received the SRS resource. The serving cell may then acquire the information corresponding to TA value(s) of the candidate target cell(s).

It is noted that ‘L1/L2 mobility’, ‘mobility’, or ‘LTM’ may refer to the mobility mechanism specific for the L1 and/or L2 operations or the LTM procedure.

In some implementations, at least part of, or all of, the candidate target cells may be synchronized with the serving cell in a case that at least one of the following circumstances (1) to (6) occurs:
(1) The candidate target cell(s) may inform the serving cell of the receiving time of an uplink resource (e.g., the SRS resource). For example, the candidate target cell(s) may transmit the information about the receiving time of an uplink resource via an F1 interface message to the CU, where the CU controls the serving cell and the candidate target cell(s). The CU may then transmit the information about the receiving time of an uplink resource via an F1 interface message to the serving cell. When the serving cell receives the information about the receiving time of the uplink resource, the serving cell may synchronize with the candidate target cell(s). It is noted that the F1 interface message may refer to be a message or signaling between the CU and DU.
(2) A CU that controls the candidate target cell(s) and the serving cell may send a request message via an F1 interface message to the candidate target cell(s) and/or the serving cell to request the information about the receiving time of an uplink resource. For example, the CU may send the request periodically or when a certain event is triggered. Upon receiving the request from the CU, the candidate target cell(s) and the serving cell may respond with the information about the receiving time of an uplink resource via an F1 interface message to the CU. After getting the information about the receiving time of an uplink resource, the CU may send indication to the candidate target cell(s) and the serving cell via an F1 interface message to specify whether the receiving cell is synchronized with other cells under the CU's control. It is noted that the F1 interface message may refer to be a message or signaling between the CU and DU.
(3) The serving cell may send a request message that requests the information about the receiving time of an uplink resource associated with the candidate target cell(s) configured for the UE, via an F1 interface message to the CU that controls the serving cell and the candidate target cell(s). In some implementations, the serving cell may subsequently receive the indication that specifies whether the candidate target cell(s) for the UE is synchronized with the serving cell, via an F1 interface message from the CU. In some implementations, the serving cell may receive the information about the receiving time of an uplink resource associated with the candidate target cell(s) for the UE via an F1 interface message from the CU. In some implementations, after the CU receives the request message from the serving cell, the CU may send a request message asking for the information about the receiving time of an uplink resource to some or all candidate cells for the UE via an F1 interface message. It is noted that the F1 interface message may refer to a message or signaling between the CU and DU.
(4) The candidate target cell(s) may synchronize with the serving cell when these candidate target cells belong to the same DU. In other words, the relationship between the candidate target cell(s) and the serving cell is intra-DU.
(5) The candidate target cell(s) and the serving cell are configured for a UE to perform an SFN transmission.
(6) The candidate target cell(s) and the serving cell are configured for a UE to perform a CJT transmission.

In some implementations, the UE may perform a RACH procedure for the inter-DU candidate target cell(s) to acquire the initial TA value. For the intra-DU candidate target cell(s), the UE may not need to perform a RACH procedure to obtain the initial TA value. Instead, the UE may assume that the initial TA value for the intra-DU candidate target cell(s) is the same as the initial TA value (or the current TA value) of the serving cell. In the present disclosure, the intra-DU candidate target cell(s) may refer to the candidate target cell(s) where the relationship between such cell(s) and the serving cell is intra-DU. Conversely, the inter-DU candidate target cell(s) may refer to the candidate target cell(s) where the relationship with the serving cell is inter-DU.

In some implementations, the NW may indicate to the UE whether to perform a TA value acquisition procedure for an intra-DU candidate target cell. In some implementations, the NW may provide a list of intra-DU candidate target cells. For an intra-DU candidate target cell on the list, the UE may not perform (e.g., forgo performing) a TA value acquisition procedure and may use the initial TA value (or the current TA value) of the serving cell as the initial TA value for the intra-DU candidate target cell.

In some implementations, the UE may be indicated to perform a cell switching to switch to a candidate target cell based on the DCI transmitted by a gNB/BS. If the indicated candidate target cell is an intra-DU candidate target cell, the UE may not be expected to perform a RACH procedure for the indicated candidate target cell. However, if the indicated candidate cell is an inter-DU candidate target cell, the UE may initiate a RACH procedure for the indicated candidate target cell to acquire the initial TA value.

In some implementations, if a UE attempts to access a candidate target cell via a RACH-less mechanism/procedure (e.g., by referring to a stored TA value) and fails, the UE may fallback to performing a RACH procedure to access the candidate target cell and/or acquire an initial TA value. In some implementations, if the UE attempts to access a candidate target cell via a RACH-less mechanism (e.g., by referring to a stored TA value) and does not succeed within a designated time period, the UE may fallback to performing a RACH procedure to access the candidate target cell and/or acquire the initial TA value. The UE may consider the access to a candidate target cell successful when the UE is able to transmit UL signaling via a pre-configured UL grant to the candidate target cell and/or receive the corresponding feedback. The pre-configured UL grant may be transmitted via a MAC CE or DCI and may be used to indicate to the UE to switch from its current source serving cell/beam to a target candidate cell/beam. If no pre-configured UL grant is provided, the UE may start monitoring the PDCCH configured for the target candidate cell/beam. In some implementations, for the RACH-less mechanism/procedure, the UE may transmit UL data to the target cell using a pre-configured UL grant after the UE receives the cell switch MAC CE. If the UL grant is not pre-configured, the UE may monitor the PDCCH to obtain the resource for transmit the UL data to the target cell. If the UE receives feedback from the target cell, the UE may determine that the LTM procedure is complete or successful. The pre-configured UL grant may be configured by RRC signaling. The UE may monitor the PDCCH using the TCI state as indicated in the cell switch MAC CE.

In some implementations, the UE may be indicated by the gNB/BS/serving cell to perform a cell switching through the DCI transmitted from the gNB/BS/serving cell. The search space and/or the RNTI dedicated for L1/L2 mobility may be configured for the UE to receive the DCI that includes a cell switch command. For example, the DCI may include one or more of the following fields (1) to (3):
(1) A field used to indicate to perform a cell switching.
(2) A field used to indicate which candidate target cell the UE should switch to (e.g., an additionalPCIIndex).
(3) A field used to indicate whether to perform the RACH procedure for the indicated candidate target cell. If the field indicates not to perform the RACH procedure, the UE may apply the TA value corresponding to the serving cell for the indicated candidate target cell.

In some implementations, the UE may receive indication to perform a cell switching via a cell switch MAC CE from the gNB/BS/serving cell. The search space and/or the RNTI dedicated for L1/L2 mobility may be configured for the UE to receive the DCI that indicates to the UE to receive the cell switch MAC CE. The cell switch MAC CE may include at least one of the following fields (1) to (4):
(1) A field used to indicate which candidate target cell the UE should switch to (e.g., an additionalPCIIndex or an LTM candidate cell index).
(2) A TA command.
(3) A field used to indicate whether to perform a RACH procedure for the indicated candidate target cell. If the field indicates not to perform the RACH procedure, the UE may apply the TA value corresponding to the serving cell for the indicated candidate target cell.
(4) A TCI state corresponding to the indicated candidate target cell.

In some implementations, the UE may be configured with one or more timers for switching between the L3 mobility procedure and the L1/L2 mobility procedure. For example, a configured timer may start upon the UE receiving L1/L2 signaling to switch to a candidate cell/beam. If the UE does not successfully perform an L1/L2 cell switching while the configured timer is running, the UE may trigger an RLF procedure or switch to the L3 mobility procedure. The configured timer may stop when the access to the candidate cell/beam is successful. In some implementations, in a case that the timer expires (indicating that the UE does not successfully complete the L1/L2 mobility procedure within the specified time period), the UE may trigger the RLF procedure or switch to the L3 mobility procedure. In some implementations, in a case that the LTM procedure fails, the UE may resume the connection to the previous serving cell. In some implementations, in a case that the LTM procedure fails, the UE may report the related LTM failure information to the NW.

In some implementations, the UE may receive multiple pre-configurations corresponding to different candidate target cells and a threshold used to determine whether to perform a cell switching via RRC signaling. Each pre-configuration may include at least one of the following pieces of information (1) to (5):
(1) A TAG ID.
(2) A RACH configuration.
(3) A specific index (e.g., an additionalPCIIndex).
(4) A TCI state and/or a list of TCI states.
(5) An SSB configuration.

After receiving the pre-configurations (corresponding to different candidate target cells) and the threshold, the UE may perform a channel measurement for each candidate target cell. The UE may then report to the gNB any candidate target cells that have a channel quality surpassing the configured threshold. For the candidate target cell(s) reported by the UE, the UE may perform the RACH procedure to acquire their initial TA value(s). The UE may receive a cell switch command via DCI or a MAC CE. In a case that the cell switch command is received by the UE via the DCI, the DCI may include at least one of the following fields (1) to (3):
(1) A field used to indicate to the UE to perform a cell switching.
(2) A field used to indicate which candidate target cell the UE should switch to (e.g., an additionalPCIIndex).
(3) A field used to indicate to the UE whether to perform a RACH procedure for the indicated candidate target cell. If this field indicates to the UE not to perform a RACH procedure, the UE may apply the TA value corresponding to the serving cell for the indicated candidate target cell.

In some implementations, the DCI may indicate to the UE to receive a TA command MAC CE corresponding to the candidate target cell to which the gNB/BS indicates to the UE to switch. Subsequently, the UE may switch to the candidate target cell as indicated by the gNB/BS.

In some implementations, the UE may receive multiple pre-configurations, each corresponding to a different candidate target cell. Along with these pre-configurations, the UE may also receive, via RRC signaling, a threshold to determine whether a cell switching should be performed. Each pre-configuration may include at least one of the following pieces of information, from (1) to (6):
(1) A TAG ID.
(2) A RACH configuration.
(3) A specific index (e.g., an additionalPCIIndex).
(4) A TCI state and/or a list of TCI states.
(5) An SSB configuration.
(6) An identifier specifying whether the relationship between the serving cell and the candidate target cell is inter-DU (e.g., ‘0’) or intra-DU (e.g., ‘1’).

After receiving the pre-configurations for different candidate target cells along with the threshold, the UE may perform a channel measurements for each candidate target cell. The UE may then report to the gNB any candidate target cells that have a channel quality surpassing the configured threshold. For the inter-DU candidate target cell(s) identified by this criterion, the UE may perform a RACH procedure to acquire their initial TA value(s). The UE may receive a cell switch command via DCI or a MAC CE. If the cell switch command is received via the DCI, the DCI may include one or more of the following fields (1) to (3):
(1) A field used to indicate to the UE to perform a cell switching.
(2) A field used to specify to which candidate target cell the UE should switch (e.g., an additionalPCIIndex).
(3) A field used to indicates to the UE whether to perform a RACH procedure for the indicated candidate target cell. If this field indicates to the UE not to perform a RACH procedure, the UE may apply the TA value corresponding to the serving cell for the indicated candidate target cell.

In some implementations, the DCI may indicate to the UE to receive a TA command MAC CE corresponding to the candidate target cell to which the gNB/BS indicates to the UE to switch. In a case that the inter-DU candidate target cell is indicated by the gNB/BS for a cell switching, the TA command MAC CE received by the UE may include a TAG ID listed in the pre-configuration associated with the indicated inter-DU candidate target cell. In a case that the intra-DU candidate target cell is indicated by the gNB/BS for a cell switching, the TA command MAC CE received by the UE may include a TAG ID being same as the TAG ID configured to serving cell. The UE may then perform a cell switching to the candidate target cell indicated by the gNB/BS.

In some implementations, the UE may be configured, by RRC signaling, with a timer value for a cell switching. For example, the UE may set a timer specific for the L1/L2 mobility procedure with the received timer value. The UE may start the timer when the UE receives the timer value or when the UE begins to perform the L1/L2 mobility procedure. In a case that the UE does not successfully perform the L1/L2 mobility procedure for the cell switching upon the timer set to the specified timer value expires, the UE may trigger an RLF procedure or switch to the L3 mobility procedure.

In some implementations, the UE may be configured, by RRC signaling, with a maximum number of L1/L2 cell switch failures. If the L1/L2 mobility procedure fails, the UE may increment the count of the L1/L2 cell switch failures by one. In a case that the number of times the UE does not successfully perform the L1/L2 mobility procedure is larger than, or equal to, the maximum number of L1/L2 cell switch failures, the UE may trigger an RLF procedure or switch to the L3 mobility procedure. In the present disclosure, the L3 mobility procedure may pertain to the mobility mechanisms triggered by and/or operated by L3 (e.g., the RRC layer).

In some implementations, the UE may receive at least one candidate cell configuration via RRC signaling from the source cell. The UE may then receive a cell switch MAC CE, which indicates the candidate target cell (or target cell) to which the UE should switch. In a case that the pre-configuration (or candidate cell configuration) for the target cell indicates that the TA value of the target cell is the same as that of the source cell (or serving cell), the UE may apply the TA value of the source cell to the target cell.

In some implementations, in a case that the UE employs a RACH-less scheme, the UE may transmit the UL data to the target cell using a pre-configured UL grant after receiving the cell switch MAC CE. In a case that the UE receives feedback from the target cell, the UE may determine that the LTM procedure has been completed. In some implementations, if no UL grant is provided to the UE, the UE may monitor the PDCCH based on the TCI state indicated in the cell switch MAC CE to obtain the UL grant needed for transmitting the UL data to the target cell. If the UE receives feedback from the target cell, the UE may consider that the LTM procedure is successful or has been completed.

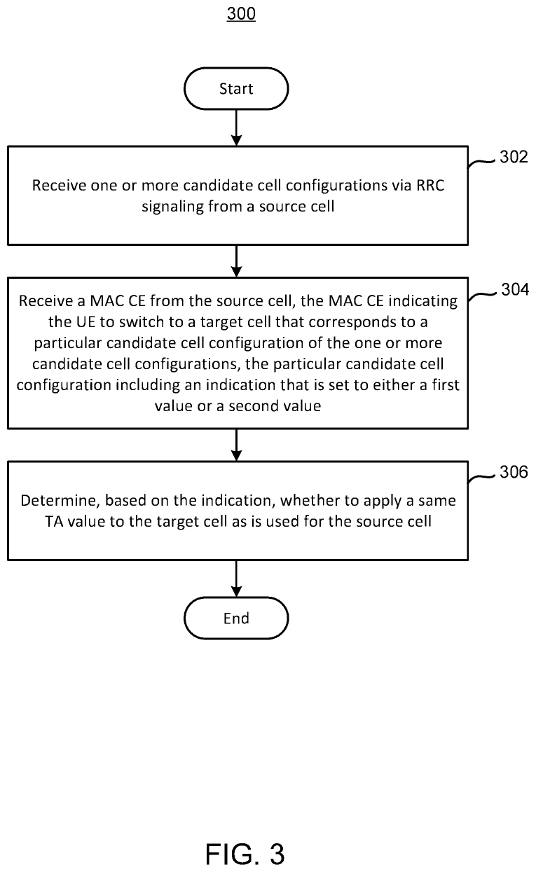

FIG. 3 is a flowchart of method 300 for a cell switching (e.g., an L1/L2 mobility procedure), according to an example implementation of the present disclosure. It should be noted that although actions 302, 304, and 306 are illustrated as separate actions represented as independent blocks in FIG. 3, these separately illustrated actions should not be construed as necessarily order-dependent. The order in which the actions are performed in FIG. 3 is not intended to be construed as a limitation, and any number of the disclosed blocks may be combined in any order to implement the method, or an alternate method. Moreover, each of actions 302, 304, and 306 may be performed independently of other actions and may be omitted in some implementations of the present disclosure.

In action 302, the UE may receive one or more candidate cell configurations via RRC signaling from a source cell. In some implementations, the candidate cell configuration(s) may refer to the pre-configuration(s) or the LTM candidate cell configuration(s) described in the present disclosure.

In action 304, the UE may receive a MAC CE from the source cell. The MAC CE (e.g., a cell switch MAC CE) may indicate the UE to switch to a target cell that corresponds to a particular candidate cell configuration of the one or more candidate cell configurations. The particular candidate cell configuration may include an indication that is set to either a first value or a second value.

In action 306, the UE may determine, based on the indication, whether to apply a same TA value to the target cell as is used for the source cell.

Leveraging method 300 addresses the issue of acquiring and maintaining the TA value for the target cell during the L1/L2 mobility procedure in NR. By effectively determining the appropriate TA value for the target cell, method 300 reduces the latency traditionally associated with the L1/L2 mobility procedure. This optimized method ensures a seamless handover experience, further reducing interruption time and elevating service continuity.

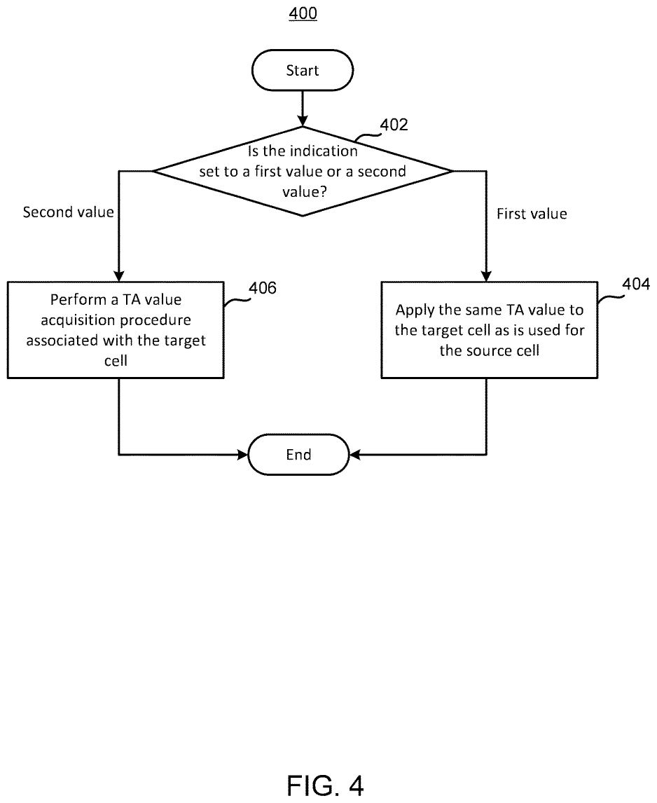

FIG. 4 is a diagram illustrating procedure 400 for determining the TA value by the UE, according to an example implementation of the present disclosure. The procedure 400 may be considered as either a further elaboration of method 300 illustrated in FIG. 3 (e.g., action 306 of FIG. 3), providing more detailed actions, or as an independent approach providing a more detailed or alternative way of addressing TA value determinations based on specific indications or conditions.

In action 402, the UE may determine that the indication is set to a first value or a second value.

In action 404, the UE may apply the same TA value to the target cell as is used for the source cell in a case that the indication is set to the first value.

In action 406, the UE may perform a TA value acquisition procedure associated with the target cell in a case that the indication is set to the second value.

In some implementations, in the case that the indication is set to the first value, the UE may further perform one or more of the following actions: (1) transmitting uplink data to the target cell after receiving the MAC CE, (2) receiving feedback associated with the uplink data from the target cell, and (3) determining that the cell switching is complete after receiving the feedback from the target cell.

In some implementations, in the case that the indication is set to the first value, the UE may further perform one or more of the following actions: (1) monitoring a PDCCH based on a TCI state indicated by the MAC CE in a case that the particular candidate cell configuration does not configure an uplink grant for the UE to transmit uplink data to the target cell, (2) obtaining an uplink grant from the PDCCH, (3) transmitting, by using the uplink grant, the uplink data to the target cell after receiving the MAC CE, (4) receiving feedback associated with the uplink data from the target cell, and (5) determining that the cell switching is complete after receiving the feedback from the target cell.

In some implementations, when the indication is set to the first value, the indication signifies an intra-DU relationship between the target cell and the source cell. When the indication is set to the second value, the indication signifies an inter-DU relationship between the target cell and the source cell. For example, the indication be a specific IE adopting an ENUMERATED format (e.g., ENUMERATED{‘inter-DU’, ‘intra-DU’}). If the IE (or the bit specified by the IE) is set to a first value (e.g., ‘0’), the relationship between the associated candidate target cell and the serving cell is ‘inter-DU’. If the IE (or the bit specified by the IE) is set to a second value (e.g., ‘1’), the relationship between the associated candidate target cell and the serving cell is ‘intra-DU’. Additionally, the indication may have alternative implementations. For example, the indication may take on formats such as ENUMERATED{‘intra-DU’} or ENUMERATED{‘inter-DU’}, with different values of the indication corresponding to either ‘inter-DU’ or ‘intra-DU’ relationships.

In some implementations, the TA value acquisition procedure may include a RACH procedure. For example, the TA value acquisition procedure may be implemented as part or the entirety of a RACH procedure.

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception. Consequently, the methods or actions executed by the BS may be combined or integrated in a similar manner to how the methods or actions are executed by the UE.

For example, when viewed from the BS's perspective, method 300 may correspond to a method performed by the BS. Specifically, the BS may transmit one or more candidate cell configurations to the UE via RRC signaling and transmit a MAC CE to the UE. The MAC CE may indicate the UE to switch to a target cell that corresponds to a particular candidate cell configuration of the one or more candidate cell configurations. The particular candidate cell configuration may include an indication that is set to either a first value or a second value. The MAC CE may enable the UE to determine, based on the indication, whether to apply a same TA value to the target cell as is used for a source cell.

In some implementations, the BS may enable the UE to apply the same TA value to the target cell as is used for the source cell by setting the indication to the first value and enable the UE to perform a TA value acquisition procedure associated with the target cell by setting the indication to the second value.

In some implementations, when the indication is set to the first value, the indication signifies an intra-DU relationship between the target cell and the source cell. When the indication is set to the second value, the indication signifies an inter-DU relationship between the target cell and the source cell.

In some implementations of the third aspect of the present disclosure, the TA value acquisition procedure may include a RACH procedure.

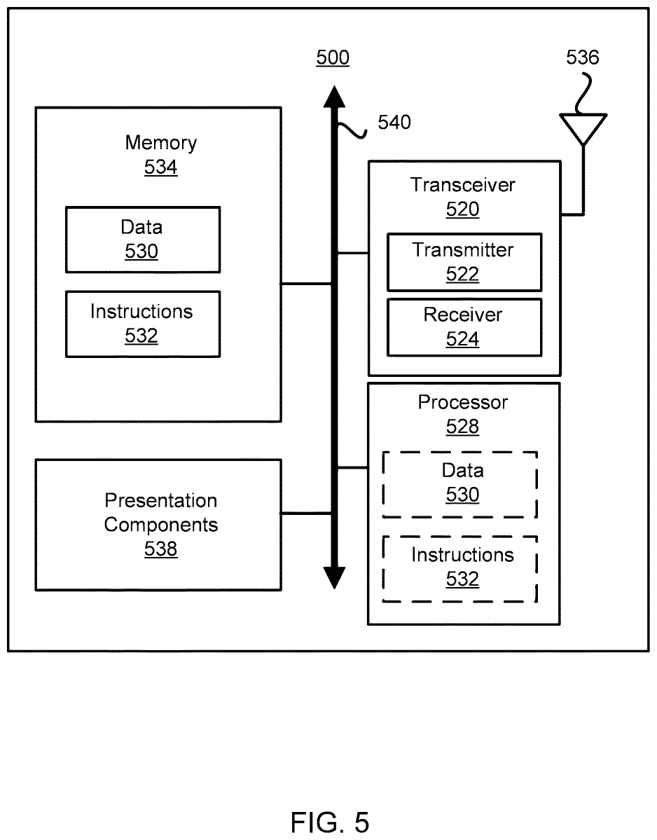

FIG. 5 is a block diagram illustrating a node for wireless communication in accordance with various aspects of the present disclosure. As illustrated in FIG. 5, node 500 may include transceiver 520, processor 528, memory 534, one or more presentation components 538, and at least one antenna 536. Node 500 may also include a radio frequency (RF) spectrum band module, a BS communications module, a network communications module, and a system communications management module, Input/Output (I/O) ports, I/O components, and a power supply (not illustrated in FIG. 5).

Each of the components may directly or indirectly communicate with each other over one or more buses 540. Node 500 may be a UE or a BS that performs various functions disclosed with reference to FIGS. 1 through 4.

Transceiver 520 has transmitter 522 (e.g., transmitting/transmission circuitry) and receiver 524 (e.g., receiving/reception circuitry) and may be configured to transmit and/or receive time and/or frequency resource partitioning information. Transceiver 520 may be configured to transmit in different types of subframes and slots including, but not limited to, usable, non-usable, and flexibly usable subframes and slot formats. Transceiver 520 may be configured to receive data and control channels.

Node 500 may include a variety of computer-readable media. Computer-readable media may be any available media that may be accessed by node 500 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

Memory 534 may include computer-storage media in the form of volatile and/or non-volatile memory. Memory 534 may be removable, non-removable, or a combination thereof. Example memory may include solid-state memory, hard drives, optical-disc drives, etc. As illustrated in FIG. 5, memory 534 may store a computer-readable and/or computer-executable instructions 532 (e.g., software codes) that are configured to, when executed, cause processor 528 to perform various functions disclosed herein, for example, with reference to FIGS. 1 through 4. Alternatively, instructions 532 may not be directly executable by processor 528 but may be configured to cause node 500 (e.g., when compiled and executed) to perform various functions disclosed herein.

Processor 528 (e.g., having processing circuitry) may include an intelligent hardware device, e.g., a Central Processing Unit (CPU), a microcontroller, an ASIC, etc. Processor 528 may include memory. Processor 528 may process data 530 and instructions 532 received from memory 534, and information transmitted and received via transceiver 520, the baseband communications module, and/or the network communications module. Processor 528 may also process information to send to transceiver 520 for transmission via antenna 536 to the network communications module for transmission to a CN.

One or more presentation components 538 may present data indications to a person or another device. Examples of presentation components 538 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method performed by a User Equipment (UE) for a cell switching, the method comprising:
receiving one or more candidate cell configurations via Radio Resource Control (RRC) signaling from a source cell;
receiving a Medium Access Control (MAC) Control Element (CE) from the source cell, the MAC CE indicating to the UE to switch to a target cell that corresponds to a particular candidate cell configuration of the one or more candidate cell configurations, the particular candidate cell configuration comprising an indication that is set to either a first value or a second value; and
determining, based on the indication, whether to apply a same Timing Advance (TA) value that is used for the source cell to the target cell.

2-6. (canceled)

7. A User Equipment (UE) for a cell switching, the UE comprising:
at least one processor; and
at least one non-transitory machine-readable medium coupled to the at least one processor and storing one or more computer-executable instructions that, when executed by the at least one processor, cause the UE to:
receive one or more candidate cell configurations via Radio Resource Control (RRC) signaling from a source cell;
receive a Medium Access Control (MAC) Control Element (CE) from the source cell, the MAC CE indicating to the UE to switch to a target cell that corresponds to a particular candidate cell configuration of the one or more candidate cell configurations, the particular candidate cell configuration comprising an indication that is set to either a first value or a second value; and
determine, based on the indication, whether to apply a same Timing Advance (TA) value that is used for the source cell to the target cell.

8. The UE of claim 7, wherein determining, based on the indication, whether to apply the same TA value to the target cell further comprises:
applying the same TA value that is used for the source cell to the target cell in a case that the indication is set to the first value; and
performing a TA value acquisition procedure associated with the target cell in a case that the indication is set to the second value.

9. The UE of claim 7, wherein the one or more computer-executable instructions, when executed by the at least one processor, further cause the UE to:
in the case that the indication is set to the first value:
transmit uplink data to the target cell after receiving the MAC CE;
receive a feedback associated with the uplink data from the target cell; and
determine that the cell switching is completed after receiving the feedback from the target cell.

10. The UE of claim 7, wherein the one or more computer-executable instructions, when executed by the at least one processor, further cause the UE to:
in the case that the indication is set to the first value:
monitor a Physical Downlink Control Channel (PDCCH) based on a Transmission Configuration Indicator (TCI) state indicated by the MAC CE in a case that the particular candidate cell configuration does not configure an uplink grant for the UE to transmit uplink data to the target cell;
obtain an uplink grant from the PDCCH;
transmit, by using the uplink grant, the uplink data to the target cell after receiving the MAC CE;
receive a feedback associated with the uplink data from the target cell; and
determine that the cell switching is completed after receiving the feedback from the target cell.

11. The UE of claim 7, wherein:
in a case that the indication is set to the first value, the indication signifies an intra-Distributed Unit (intra-DU) relationship between the target cell and the source cell, and
in a case that the indication is set to the second value, the indication signifies an inter-Distributed Unit (inter-DU) relationship between the target cell and the source cell.

12. The UE of claim 8, wherein the TA value acquisition procedure comprises a Random Access Channel (RACH) procedure.

13. A Base Station (BS) for managing a cell switching of a User Equipment (UE), the BS comprising:
at least one processor; and
at least one non-transitory machine-readable medium coupled to the at least one processor and storing one or more computer-executable instructions that, when executed by the at least one processor, cause the BS to:
transmit one or more candidate cell configurations to the UE via Radio Resource Control (RRC) signaling; and
transmit a Medium Access Control (MAC) Control Element (CE) to the UE, the MAC CE indicating to the UE to switch to a target cell that corresponds to a particular candidate cell configuration of the one or more candidate cell configurations, the particular candidate cell configuration comprising an indication that is set to either a first value or a second value,
wherein the MAC CE enables the UE to determine, based on the indication, whether to apply a same Timing Advance (TA) value that is used for a source cell to the target cell.

14. The BS of claim 13, wherein the one or more computer-executable instructions, when executed by the at least one processor, further cause the BS to:
enable the UE to apply the same TA value that is used for the source cell to the target cell by setting the indication to the first value; and
enable the UE to perform a TA value acquisition procedure associated with the target cell by setting the indication to the second value.

15. The BS of claim 13, wherein:
in a case that the indication is set to the first value, the indication signifies an intra-Distributed Unit (intra-DU) relationship between the target cell and the source cell; and
in a case that the indication is set to the second value, the indication signifies an inter-Distributed Unit (inter-DU) relationship between the target cell and the source cell.

16. The BS of claim 14, wherein the TA value acquisition procedure comprises a Random Access Channel (RACH) procedure.
